(19) United States
(12) Patent Application Publication
(10) Pub. No.: US 2002/0092837 A1
(43) Pub. Date: Jul. 18, 2002

(54) Welding electrode holder

(76) Inventor: David John Keats, Cleckheaton (GB)

Correspondence Address: VENABLE, BAETJER, HOWARD AND CIVILETTI, LLP, P.O. BOX 34385, WASHINGTON, DC, 20043-9998, US

(21) Appl. No.: 10/042,277

(22) Filed: Jan. 11, 2002

(30) Foreign Application Priority Data
Jan. 12, 2001 (GB) 0100877.0

(51) Int. Cl. B23K 9/28

(52) U.S. Cl. 219/142; 219/137.63

(57) ABSTRACT

A welding electrode holder 10 comprises a body portion 12, a cable holding section 14, a cable collet 16 and an electrode clamping section 18. An electrical cable 20 from a power supply is held in the cable holding section 14 which is inserted into the body portion 12. An electrode 22 is inserted into an opening 24 in the body portion 12 and is clamped between the electrode clamping section 18 and a clamping head 26 of the cable holding section 14. Current is supplied to the cable 20 and is passed to the electrode via the cable holding section (which is electrically conducting) to the electrode 22 for welding to be carried out.

This invention relates to a welding electrode holder.

Electrode welding is a technique which uses electric current to provide the energy for melting welding materials to weld two pieces of metal together. An electrical circuit is made between the welding electrode, which electrode also forms the welding material, and the material to be welded.

An existing welding electrode holder comprises a fixing point for an electrical cable to supply electrical power to the electrode holder and electrode. The prior art holder consists of a pre-assembled unit having the electrical cable permanently fixed thereto.

Problems arise with the prior art welding electrode holder described above when the electrical cable breaks or needs replacing. Such an occurrence requires a user to cease welding and to obtain a fresh cable and holder assembly.

It is an object of the present invention to address the above mentioned disadvantages.

According to one aspect of the present invention a welding electrode holder comprises cable holding means, electrode clamping means and a body portion, wherein the cable holding means are operable to selectively engage or disengage a cable located therein.

The cable holding means may be arranged to be received inside the body portion, and may be removable therefrom.

The cable holding means may be securable inside the body portion, preferably by means of interengaging threads of the body portion and the cable holding means. The cable holding means may be rotationally adjustable, preferably to adjust a spacing between the cable holding means and the electrode clamping means. The adjustment may provide a standard reduction of the gap for a single rotation of a collet of the cable holding means.

The cable holding means may comprise locating means, for locating the cable holding means relative to the body portion. The locating means may comprise a recess in which a corresponding projection of the body portion is to be received.

The cable holding means may additionally comprise a collet having cable engaging projections that are arranged to extend in a direction away from a main length of the cable.

At least a part of the electrode clamping means may be receivable in the body portion, preferably in an end thereof, preferably in an end opposite to an end in which the cable holding means is received.

The electrode clamping means may be adjustable to increase or decrease the amount by which a portion thereof extends into the body portion, in order to clamp different sizes of electrode. The electrode clamping means may be removable from the body portion.

The body portion preferably includes an opening in which to receive an electrode. The opening may allow access to a space between the electrode clamping means and the cable holding means within the body portion, to allow the electrode to be gripped therebetween.

The welding electrode holder is preferably an underwater welding electrode holder.

The invention extends to a welding apparatus incorporating a welding electrode holder as described above.

A specific embodiment of the present invention will now be described by way of example with reference to the accompanying drawings, in which:

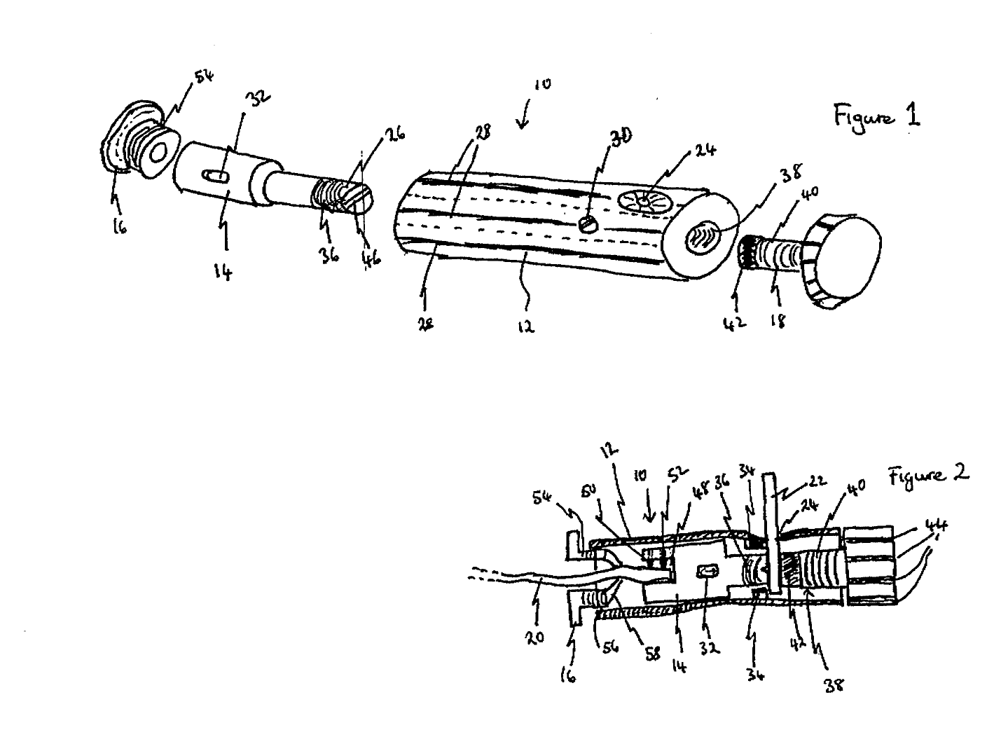

FIG. 1 is a schematic exploded perspective view of the components of a welding electrode holder; and

FIG. 2 is a schematic cross-sectional view from the side of the welding electrode holder in an assembled configuration having an electrical cable attached thereto.

A welding electrode holder 10 comprises a body portion 12, a cable holding section 14, a cable collet 16 and an electrode clamping section 18. An electrical cable 20 (see FIG. 2) from a power supply is held in the cable holding section 14 which is inserted into the body portion 12. An electrode 22 is inserted into an opening 24 in the body portion 12 and is clamped between the electrode clamping section 18 and a clamping head 26 of the cable holding section 14. Current is supplied to the cable 20 and is passed to the electrode via the cable holding section (which is electrically conducting) to the electrode 22 for welding to be carried out.

In more detail, the body portion 12 has a tubular shape, is approximately 30-40 cm long and is made of plastics material. The body portion 12 has grooves 28 on an exterior surface thereof to allow the welding electrode holder 10 to be gripped more easily. The body portion is made of electrically insulating plastics material. The body portion may also incorporate grip assisting projections, such as knobbles or ridges. The latter is particularly useful for when the electrode holder is used underwater, as is intended.

The opening 24 in the body portion 12 flares outwardly to assist a user in pushing the electrode 22 into the opening for clamping, as will be described below. The location of the opening 24 is chosen so that the electrode clamping section 18 extends within the body portion 12 up to a point level with a right hand side of the opening 24 and so that the clamping head 26 of the cable holding section 14 extends up to a left hand side of the opening 24 thus, the clamping head 26 and electrode clamping section 18 form a space beneath the opening 24 into which an electrode 22 may be inserted for subsequent clamping with the electrode clamping section 18, as will be described below.

The body portion 12 also includes a grub screw 30 which is adjustable to extend into the interior tubular opening within the body portion 12. The grub screw 30 is arranged to communicate with a groove 32 in the cable holding section 14. The cabling holding section 14 can be held in position by means of the grub screw 30 extending into the groove 32. The length of the groove 32 allows for a mismatch between the grub screw 30 and the cable holding section 14 within the body portion 12.

The body portion 12 includes a first tapped section 34 which is arranged to threadably engage a threaded section 36 of the clamping head 26. It is by means of the first tapped section 34 and the threaded section 36 that the cabling holding section 14 and clamping head 26 are held in position within the body portion 12.

The body portion 12 also includes a second tapped section 38 on the opposite side of the opening 24 to the first tapped section 34. The section tapped section 38 is arranged to receive a correspondingly threaded section 40 of the electrode clamping section 18. The body portion 12 is arranged to threadably engage with the electrode clamping section 18 which is longitudinally within the body portion by means of the communicating threads.

The electrode clamping section 18 has an electrically conducting, in this case copper, tip 42 which is arranged to abut the electrode 22. The electrode clamping section 18 is predominantly made of plastics material and has grooves 44 on an outer surface thereof to ease gripping of the electrode clamping section 18. When threaded into the body section 12 the electrically conducting tip 42 of the electrode clamping section 18 projects to the right hand side of the opening 24 as shown in FIGS. 1 and 2.

As described above the cable holding section 14 has a clamping head 26 which is electrically conducting and is arranged to extend into the body portion to the left hand side of the opening 24 as shown in FIGS. 1 and 2. The clamping head 26 has a groove 46 in which to receive and hold in position the electrode 22. The cable holding section 14 is made of electrically conducting material, in this case copper. The threaded section 36 of the clamping head 26 is provided to allow longitudinal adjustment of the cable holding section 14 relative to the body portion, such as may be necessary to allow for usual wear and tear and tolerances in the welding electrode holder. The clamping head may be advanced towards the opening 24 by 1 mm by rotating the cable holding section 14 once. The adjustment allows a good contact to be made with the electrode 22 throughout the life of the welding electrode holder.

At the opposite end of the cable holding section 14 to the clamping head 26 there is a cylindrical opening 48 in which the cable 20 is received. The cable 20 is held in position by means of grub screws 50 and 52 which extend into the opening 48 and can be turned to clamp on the cable 20.

The groove 32 in the cable holding section 14, when engaged with the grub screw 30 and the body portion 12, prevents twisting of the cable holding section 14 relative to the body portion, which twisting could cause undesired movement of the cable 20. The adjustment for wear and tear is catered for by complete rotation of the cable holding section 14. The longitudinal movement relative to the grub screw 30 is accommodated by the length of the groove 32, so a number of turns still allows the grub screw 30 to locate in the groove 32.

The cable collet 16 is made of plastics material and is threadably engaged with the body portion 12 by means of a threaded section 54 which is received in a correspondingly tapped section 56 of the body portion 12. The cable collet 16 may optionally have finger portions 58 (shown only in FIG. 2), which clamp onto the cable 20 to provide extra holding thereof. The tapered shape of the fingers 58 deters outward movement of the cable 20 away from the body portion 12. Turning the collet 6 results in the cable holding section 14 turning also, since the two are linked by the cable 20.

In use, the electrical cable 20 is passed through the is cable collet 16 and is clamped into the opening 48 in the cable holding section 14. The grub screws 50 and 52 are tightened onto the cable and the cable holding section 14 is pushed into the body portion 12 and is turned so that the thread 36 engages with the tapped section 34 of the body portion 12 until the clamping head 26 is close to alignment with a left hand side of the opening 24 in a body portion 12. When in position the grub screw 30 is tightened to engage the groove 32 in the cabling holding section 14 to prevent twisting movement of the cable holding section 14 relative to the body portion 12. The cable collet 16 is then tightened onto the end of the body portion 12, to provide extra holding of the cable 20. The electrode clamping section 18 is then pushed into the body portion at the right hand end thereof as shown in FIGS. 1 and 2. The electrode clamping section is then tightened by means of the threaded section 40 in the tapped section 38 until the electrically conducting tip 42 is approximately aligned with the right hand end of the opening 24 in the body portion 12.

An electrode 22 is then inserted into the opening 24 and between the clamping head 26 and the electrically conducting tip 42. The electrode clamping section 18 is then tightened to hold the electrode in position.

A user may then use the electrode holder 10 in the usual way.

The electrode holder 10 described above has the significant advantage that it is possible to dismantle the holder to change or adjust the cable 20, or to adjust the relative locations of the electrode clamping section 18 and the clamping head 26 for gripping the electrode 22. The adjustability of the clamping head to account for wear and tear is also extremely advantageous.

Also, the cable can be replaced considerably more quickly and efficiently than with prior art electrode holders.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. A welding electrode holder comprises cable holding means, electrode clamping means and a body portion, wherein the cable holding means are operable to selectively engage or disengage a cable located therein.

2. A welding electrode holder as claimed in claim 1, in which the cable holding means are arranged to be received inside the body portion and are removable therefrom.

3. A welding electrode holder as claimed in either claim 1 or claim 2, in which the cable holding means are securable inside the body portion.

4. A welding electrode holder as claimed in 1, in which the cable holding means are rotationally adjustable, to adjust a spacing between the cable holding means and the electrode clamping means.

5. A welding electrode holder as claimed in claim 4, in which the adjustment provides a standard reduction of the gap for a single rotation of a collet of the cable holding means.

6. A welding electrode holder as claimed in claim 1, in which the cable holding means comprise locating means, for locating the cable holding means relative to the body portion.

7. A welding electrode holder as claimed in claim 6, in which the locating means comprise a recess in which a corresponding projection of the body portion is to be received.

8. A welding electrode holder as claimed in claim 1, in which the cable holding additionally comprise a collet having cable engaging projections that are arranged to extend in a direction away from a main length the cable.

9. A welding electrode holder as claimed in claim 1, in which at least a part of the electrode clamping means is receivable in the body portion.

10. A welding electrode holder as claimed in claim 9, in which the electrode clamping means are adjustable to increase or decrease the amount by which a portion thereof extends into the body portion, in order to clamp different sizes of electrode.

11. A welding electrode holder as claimed in claim 1, in which the electrode clamping means are removable from the body portion.

12. A welding electrode holder as claimed in claim 1, in which the body portion includes an opening in which to receive an electrode.

13. A welding electrode holder as claimed in claim 12, in which the opening allows access to a space between the electrode clamping means and the cable holding means within the body portion, to allow the electrode to be gripped therebetween.

14. A welding electrode holder as claimed in claim 1, which is an underwater welding electrode holder.

15. Welding apparatus incorporates a welding electrode holder as claimed in claim 1.

16. A welding electrode holder comprises cable holding means, electrode clamping means and a body portion, wherein the cable holding means are operable to selectively engage or disengage a cable located therein, in which the cable holding means are rotationally adjustable, to adjust a spacing between the cable holding means and the electrode clamping means, in which the adjustment provides a standard reduction of the gap for a single rotation of a collet of the cable holding means.
